(19) United States
(12) Patent Application Publication
(10) Pub. No.: US 2005/0121405 A1
(43) Pub. Date: Jun. 9, 2005

(54) Pressure controlling dispensing valve for beverage container

(76) Inventor: Cornell Drajan, Hendersonville, NC (US)

Correspondence Address: SHOEMAKER AND MATTARE, LTD, 10 POST OFFICE ROAD - SUITE 110, SILVER SPRING, MD, 20910, US

(21) Appl. No.: 11/004,180

(22) Filed: Dec. 3, 2004

Related U.S. Application Data
(60) Provisional application No. 60/526,976, filed on Dec. 5, 2003.

(51) Int. Cl. A61J 9/00

(52) U.S. Cl. 215/11.4

(57) ABSTRACT

A closure for a beverage bottle contains a valve which one opens by sucking on a spout or nipple extending from the closure. The valve is normally closed, so the beverage is safely contained even it is a carbonated beverage at superatmospheric pressure. The valve is moved to its open position by a diaphragm exposed to atmospheric air on one side and to the suction on the other side. Once beverage begins to flow, the valve provides a pressure-regulating function to control the flow rate.

This application claims priority benefit from provisional patent application No. 60/526976, filed Dec. 5, 2003.

### BACKGROUND OF THE INVENTION

This invention relates to a pressure controlling dispensing valve for beverage container.

Sports bottles typically have a manually activated valve which can be opened when it is desired to take a drink, and must be manually closed thereafter. Were a carbonated beverage placed in the container, a typical sports bottle would likely spray a stream of liquid, perhaps at great velocity, as soon as the valve was opened.

### SUMMARY OF THE INVENTION

An object of the invention is to provide a closure for a container for soda drinks or the like, which will maintain soda at superatmospheric pressure, yet will permit it to be sipped from the container.

A related object is to keep carbonated beverages from going flat in a sports drink container.

These and other objects are attained by a pressure controlling dispensing valve for beverage container as described below.

### BRIEF DESCRIPTION OF THE DRAWINGS

In the accompanying drawings,

FIG. 1 is a sectional view, of a vertical bisecting plane, of a pressure controlling dispensing valve installed on an upright bottle;

FIG. 2 is a split view showing the valve in alternative positions;

FIG. 3 is a view like FIG. 1, of a second embodiment of the invention;

FIG. 4 shows a third embodiment of the invention;

FIG. 5 is a split view showing the valve in alternative positions;

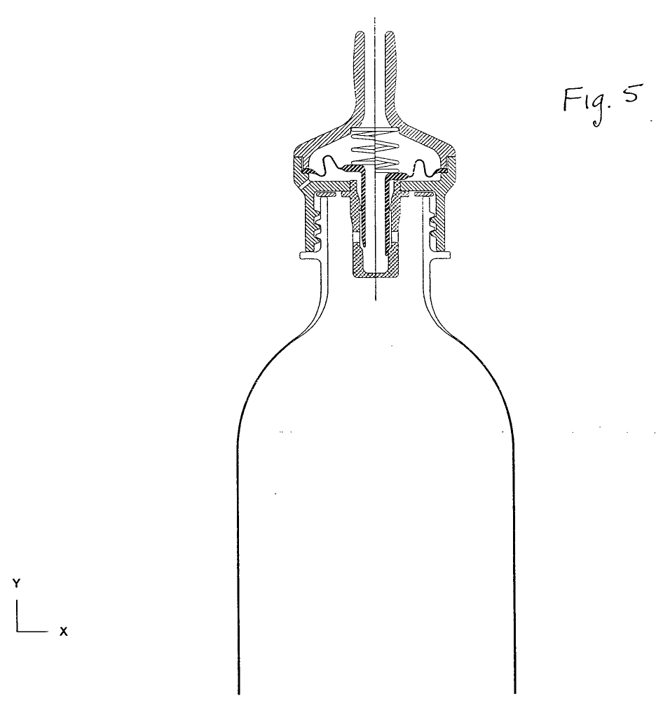

FIG. 6 shows a fourth embodiment of the invention, with the valve closed;

FIG. 7 shows the fourth embodiment with the valve open;

FIG. 8 depicts a fifth embodiment of the invention, with its valve open;

FIG. 9 depicts the fifth embodiment with its valve closed;

FIG. 10 shows the fifth embodiment in an inverted position;

FIG. 11 shows a sixth embodiment of the invention in partial section; and

FIG. 12 shows the exterior of the sixth embodiment, with its spout rotated downward.

### DESCRIPTION OF THE PREFERRED EMBODIMENT

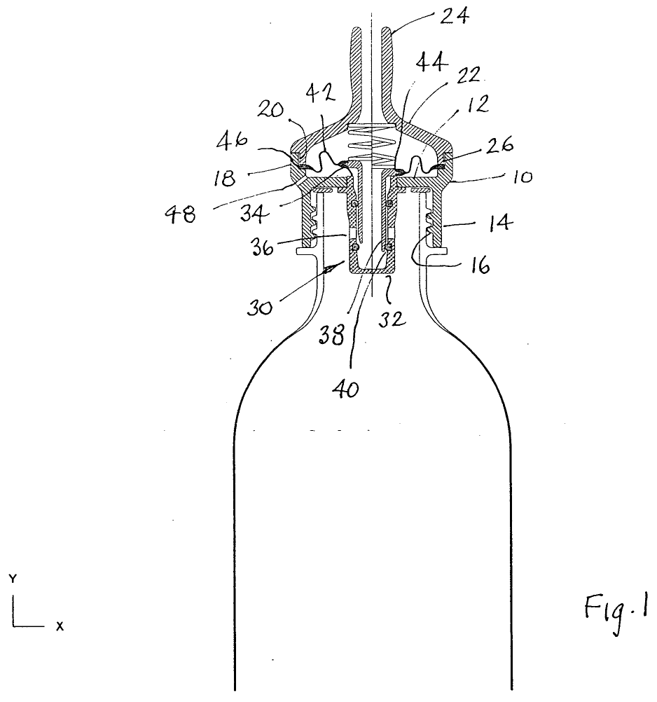

As shown in FIG. 1, a pressure controlling dispensing valve for beverage container embodying the invention comprises a body 10 having an annular plate 12 with a depending cylindrical skirt 14 having internal helical threads 16 adapted to engage external threads on a soda bottle. An upwardly extending circumferential flange 18 is counterbored at 20. The upper nipple portion 22, which has a sleeve-like mouth 24, is connected to the body 10 by welding, adhesives, or threads at the interface between its bottom flange 26 and the counterbore 20.

Flow of a beverage through the annular plate 12 is regulated by a valve 30 which has a cup-like housing 32 whose open upper end 34 is seated within the center hole of the annular plate. The cylindrical wall of the housing has a least one aperture 36 through which the beverage can pass from the bottle to the interior of the housing and thence to the nipple. The aperture is selectively blocked by a reciprocable tubular plunger 38. O-rings 40 or other seals may, if desired, be provided to prevent leakage along the exterior of the plunger.

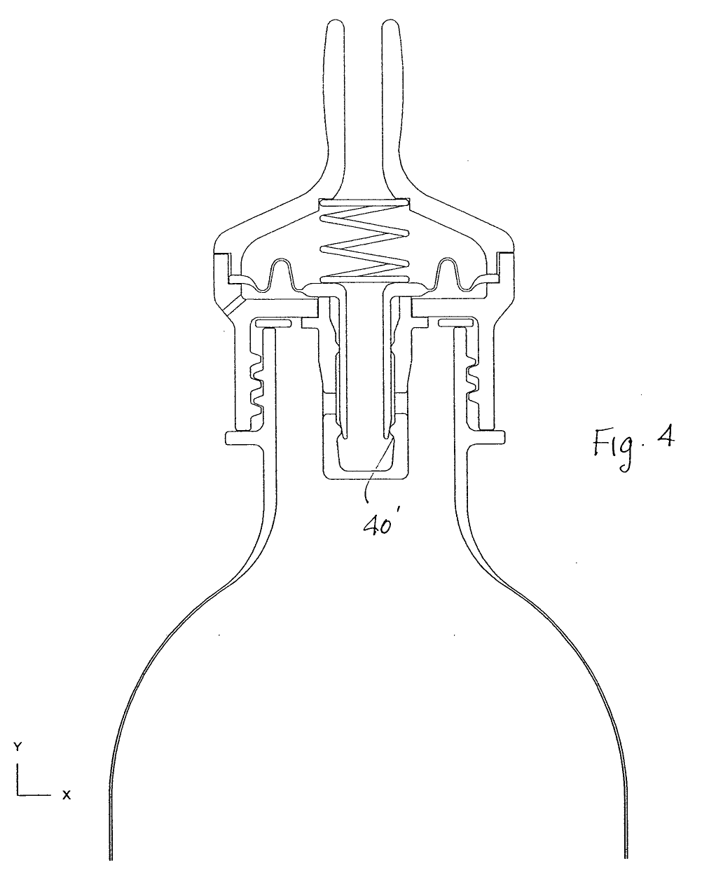

The seals can be eliminated and replaced with internal ribs 40′ (FIG. 4) if sufficiently close molding tolerances are maintained.

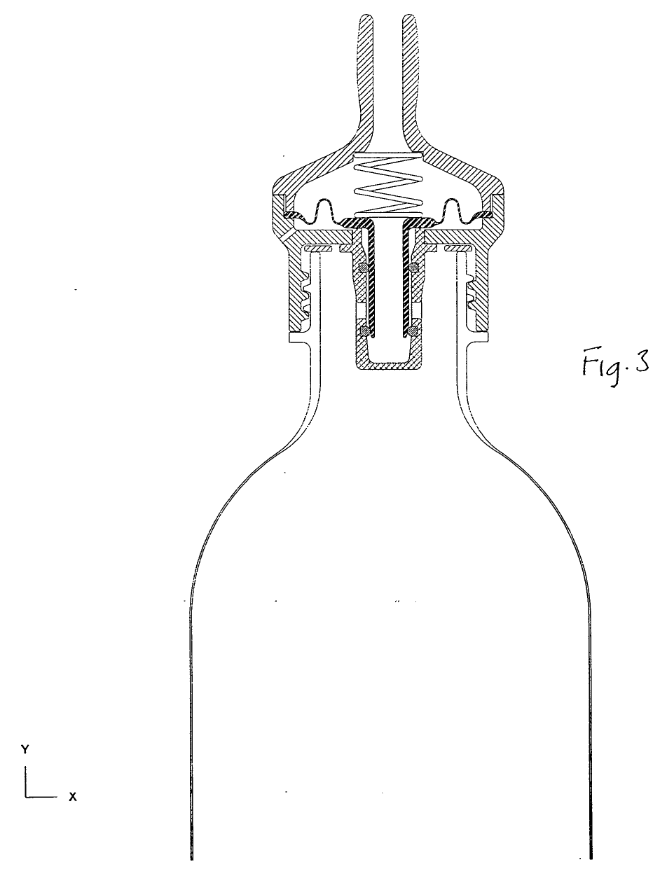

The plunger is moved up and down in the housing bore by an annular diaphragm 42 which has a central hole 44. It is possible that the diaphragm and the plunger may be molded together as a single piece (FIG. 3). The periphery 46 of the diaphragm, which preferably is thickened, is squeezed between the nipple base and the body's counterbore during assembly so that no fluid (gas or liquid) can leak past.

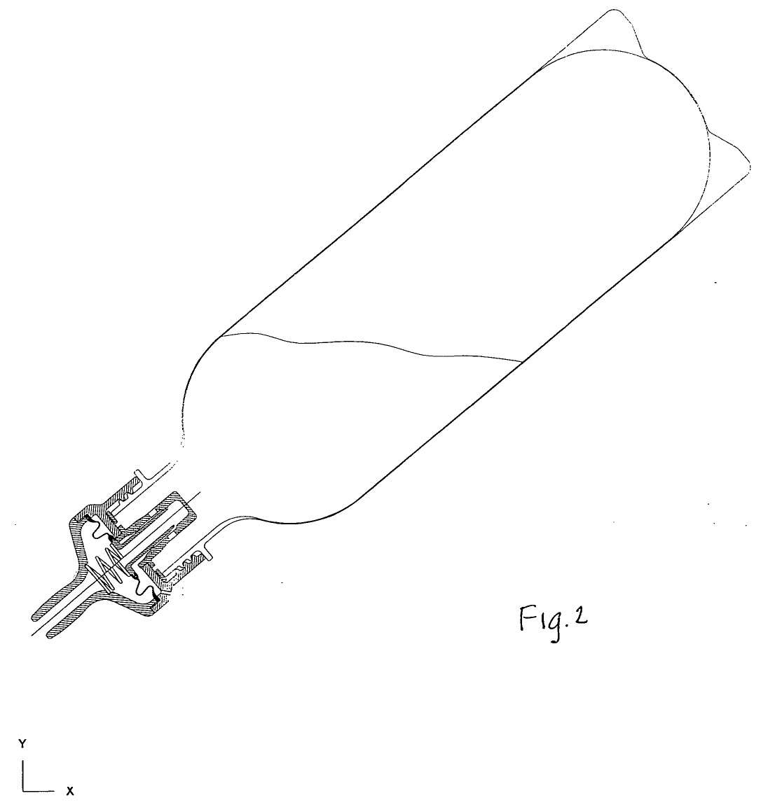

The vent hole 48 in the body maintains atmospheric pressure below the diaphragm. Since a sleeve-type plunger is not driven in any direction by pressure within the bottle, substantial pressures can build up without losing the liquid contents, or the gas pressure. Nevertheless, by applying moderate suction to the nipple with the mouth, one can easily draw the plunger upward and permit fluid to flow through the aperture(s) 36, the hole 44, and out through the nipple. (Of course, if the bottle is held upright, the fluid will be gas, so it is anticipated users will upend the container as in FIG. 2, before releasing the valve. Or, if it is desired to make the invention work upright, one could add a tube extending from the valve ports to near the bottom of the container. This tube may be sold with the valve component to permit the user to configure it to his liking.) In any event, once pressurized fluid is released by the valve, the pressure on the nipple side of the diaphragm increases, providing a pressure-regulating effect to prevent overwhelming flow rates.

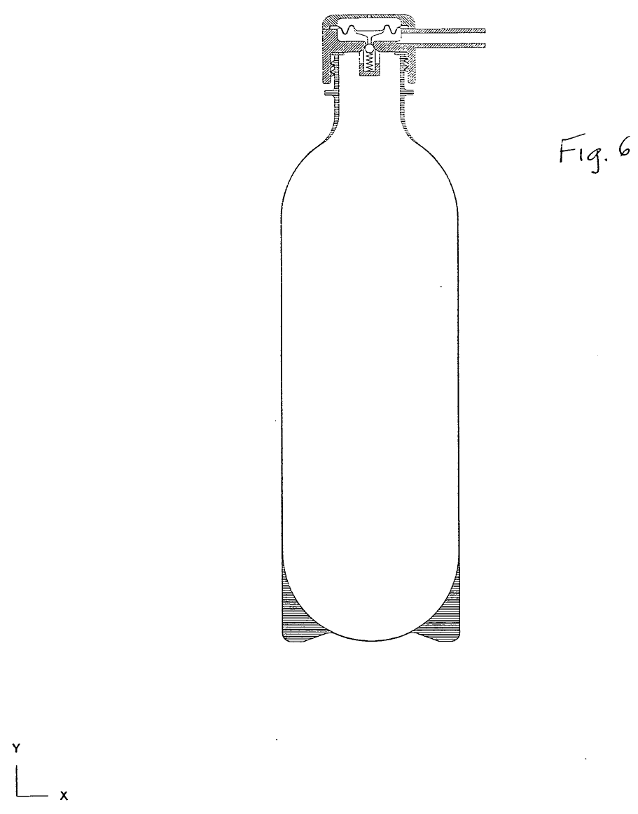

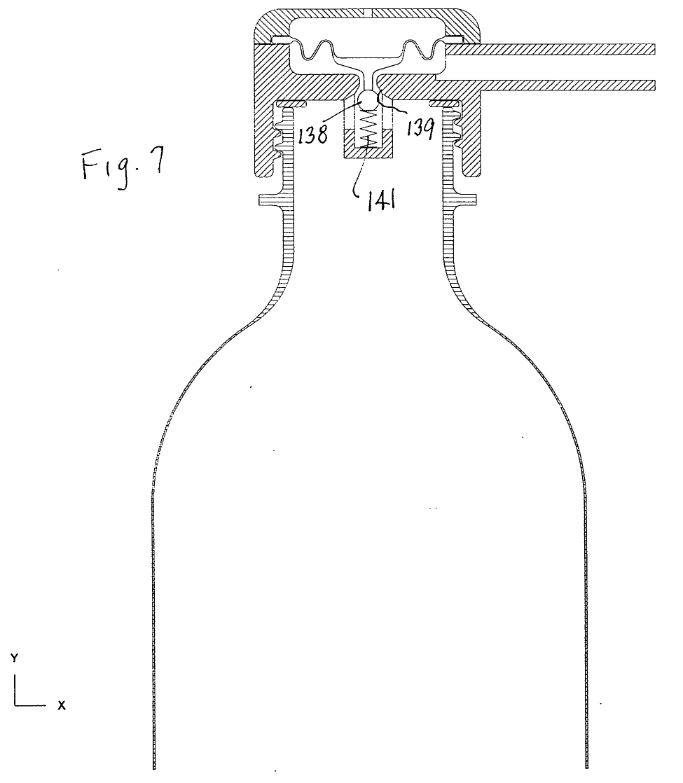

FIGS. 6-7 show a bottle having a cap in which fluid flow is controlled by a ball valve (comprising a ball 138, a seat 139 and a spring 141 pressing the ball toward the seat). The ball is unseated (FIG. 7) by the tip of an actuator at the center of a diaphragm when suction is applied to the spout extending from the cap. A vent hole at the top of the cap keeps the pressure above the diaphragm at ambient pressure.

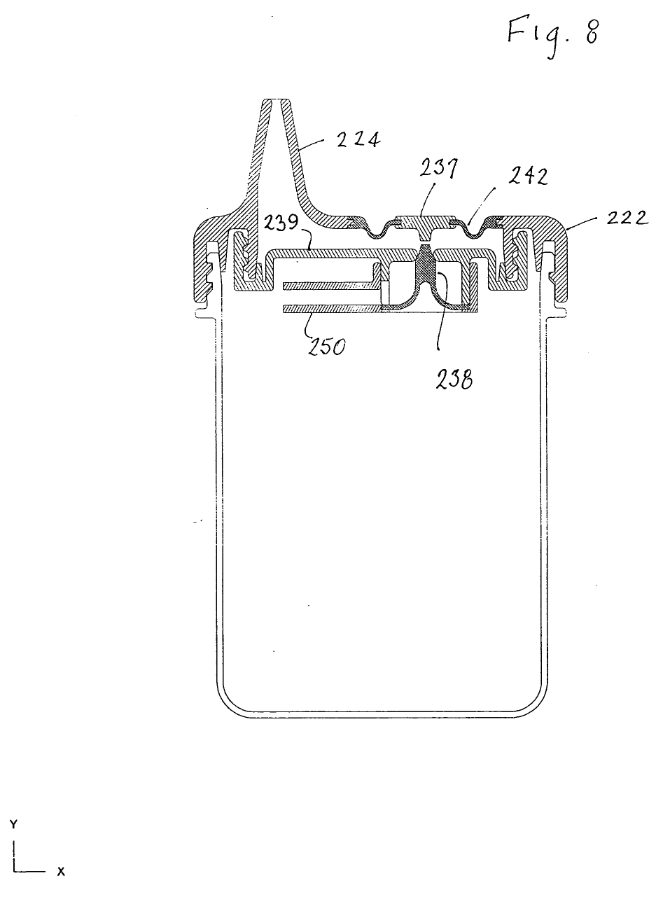

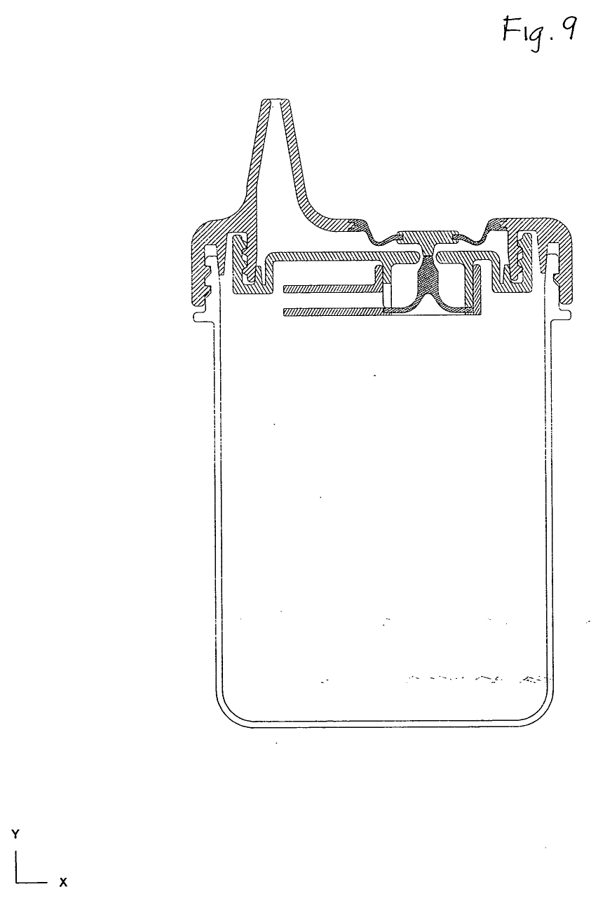

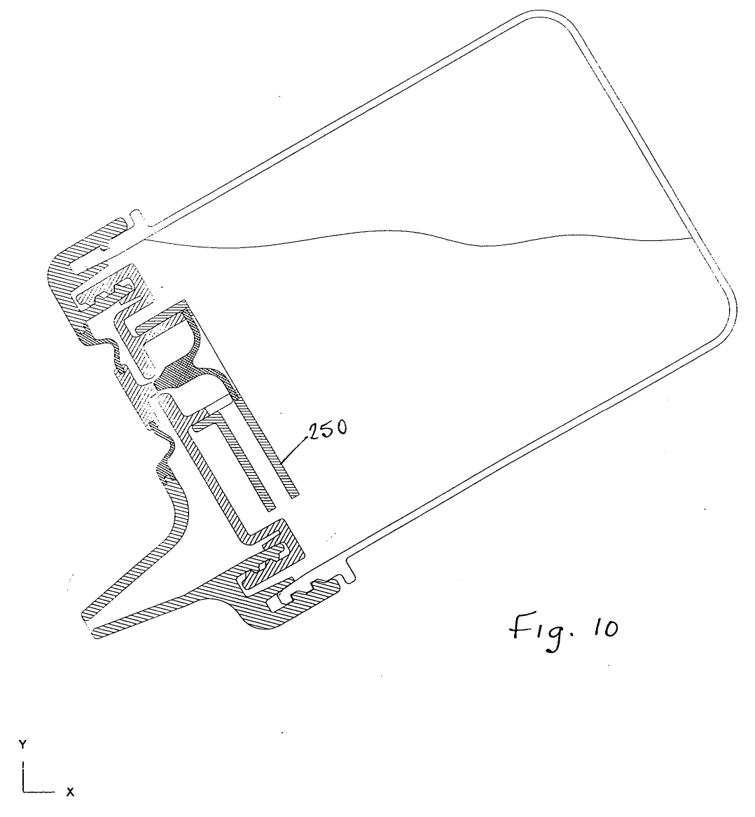

FIG. 8 illustrates a toddler's drinking cup having an outer cap 222 with an upwardly extending spout 224. The diaphragm 242 is exposed to the outside, so there is no need for a vent. The actuator 237 at the center of the diaphragm unseats (FIG. 9) a flexible valve member 238 which normally is seated in a hole in the inner cap 239. The pickup 250 leading to the valve chamber is immersed in fluid only when the cup is shown in FIG. 10 is tipped up, but as previously mentioned, the user may change the working orientation of the cup by adding a tube (not shown) extending from the pickup to the bottom of the cup.

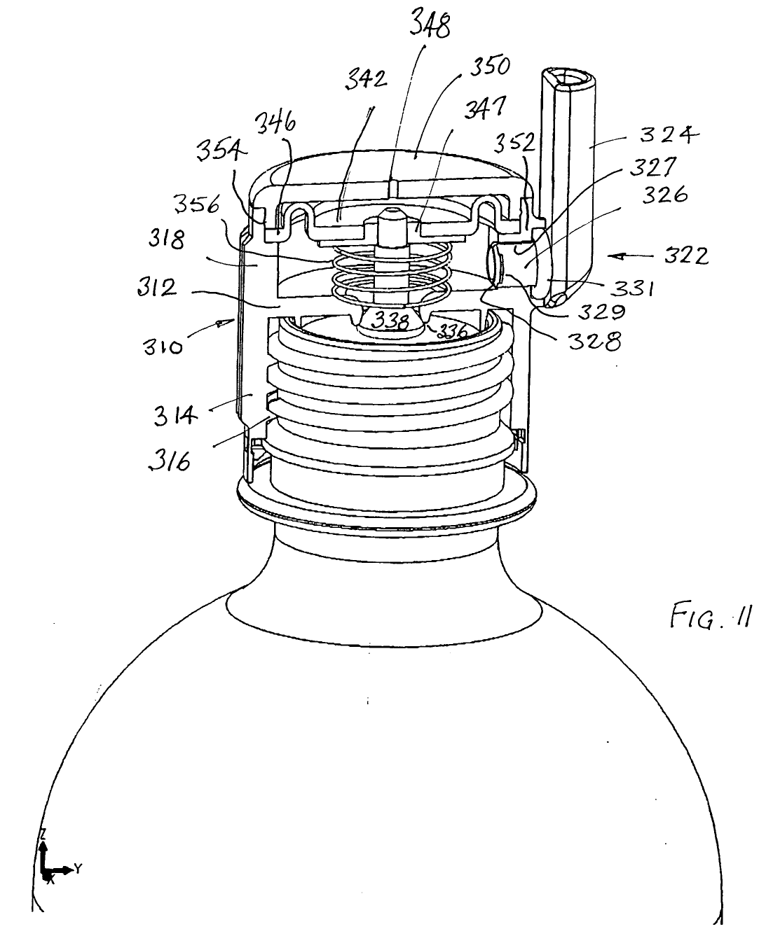

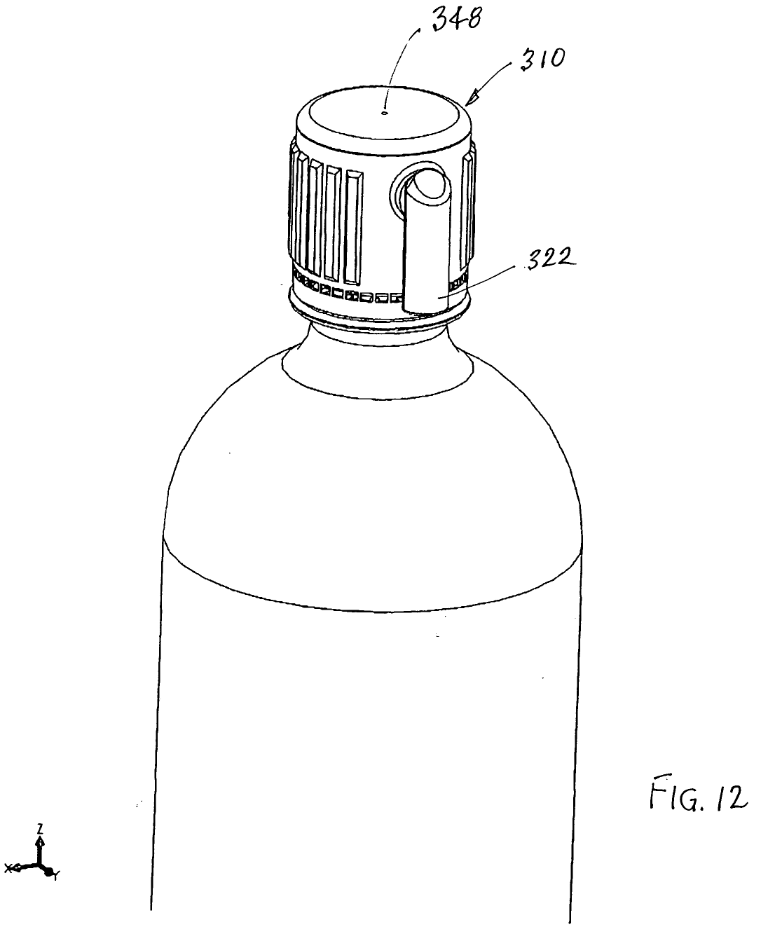

FIG. 11 discloses another embodiment of the invention. Here, the body 310 has an annular plate 312 with a depending cylindrical skirt 314 having internal helical threads 316. Instead of having an integral nipple, the upwardly extending circumferential flange 318 supports a rotary spout 322, which has a tubular distal portion 324. The proximal portion 326 is a sleeve extending through a hole 327 in the flange 318. An O-ring 331 may be provided for sealing, if necessary. The proximal portion 326 is retained in the hole by an external lip 328. Slots 329 permit the lip to deform inwardly during assembly. This arrangement permits one to pivot the spout between a vertically upward (FIG. 11) position for use, and a vertically downward (FIG. 12) position for storage and shipping.

The annular plate 312 defines a central hole 336 through which the beverage can pass from the bottle to spout 322 via the chamber defined by the plate 312 and the flange 318. The hole is selectively blocked by the head of a reciprocable plunger 338.

The plunger is moved up and down in the housing bore by an annular diaphragm 342 reinforced by a stiffener 347 which preferably is bonded to the diaphragm. The thickened periphery 346 of the diaphragm is squeezed between the closure cap 350 and the counterbore shoulder 352 so that no fluid (gas or liquid) can leak past. The cap is retained in the counterbore by interaction of a annular rib and corresponding groove identified by reference 354.

The vent hole 348 in the cap maintains atmospheric pressure above the diaphragm. By applying moderate suction to the nipple with the mouth, one can easily draw the plunger downward and permit fluid to flow through the hole 336 and out through the spout.

To keep the valve closed, a coil spring 356 may be inserted between the plate 312 and the stiffener 347. Alternatively, the diaphragm might be designed to provide enough upward bias on its own that the spring could be eliminated. Or a resilient finger or fingers (not shown) might be provided on the stiffener, pressing against the plate, or on the plate, pressing against the stiffener. All such variations are called “biasing means”.

I presently prefer that all the molded parts of the closure be made of polyethylene terephthalate (PET), except for the diaphragm which is a soft flexible material such as a rubber. However, it is expected that other materials may be substituted.

Inasmuch as the invention is subject to the variations and modifications mentioned above, and others, it is intended that the invention be measured not by the preceding description or the appended drawings, but rather by the claims which follow.

1. A closure for a container which may contain a carbonated beverage, said closure comprising
a suction-operated normally closed pressure regulating valve,
a chamber normally isolated from said container by said valve, and
a passage extending between said chamber and the exterior of the closure,
whereby a person may, by applying suction to the passage with the mouth, open the valve and draw beverage from the container via the passage.

2. The invention of claim 1, further comprising means for biasing the valve toward its closed position.

3. The invention of claim 1, further comprising a diaphragm separating the chamber into closed and vented portions, said passage communicating with said closed portion.

4. The invention of claim 3, wherein the valve is a sleeve valve.

5. The invention of claim 3, wherein the valve is a ball valve.

6. The invention of claim 3, wherein the valve is made of a substantially flexible material.

7. The invention of claim 3, wherein the passage extends through a nipple formed on the closure.

8. The invention of claim 3, wherein the passage extends through a spout having a portion outside the closure.

9. The invention of claim 8, wherein the spout has a distal portion which can be pivoted between use and storage positions.

10. The invention of claim 9, wherein the closure has a hole intersecting said closed chamber portion, and the spout has a proximal portion retained in the hole.

11. The invention of claim 10, wherein the proximal portion of the spout is retained in the hole by an external lip formed on the proximal portion.

12. The invention of claim 11, wherein plural slots are defined in the proximal portion adjacent the external lip, to facilitate insertion of the spout into the hole.
